(19) United States
(12) Patent Application Publication
(10) Pub. No.: US 2022/0414735 A1
(43) Pub. Date: Dec. 29, 2022

(54) ITEM CONDITION PREDICTION OPERATIONS AND INTERFACES IN AN ITEM LISTING SYSTEM

(71) Applicant: eBay Inc., San Jose, CA (US)

(72) Inventors: Ethan Benjamin Rubinson, San Jose, CA (US); Mark Jeffrey Weinberg, Los Gatos, CA (US); Senthil Kumar Padmanabhan, San Jose, CA (US); Parin Pankaj Jogani, San Francisco, CA (US)

(21) Appl. No.: 17/359,361

(22) Filed: Jun. 25, 2021

(51) Int. Cl. G06Q 30/06; G06N 20/00

(52) U.S. Cl. CPC G06Q 30/0625; G06Q 30/0631; G06N 20/00; G06Q 30/08

(57) ABSTRACT

Various methods and systems for providing predicted item conditions for items in an item listing system. A predicted item condition may indicate a calculated estimate of a descriptive state of the item based on item transaction features. Operationally, item transaction features of an item—associated with an item listing interface—are accessed at the item listing system. The item transaction features are communicated to an item condition prediction machine learning model of the item listing system. The item condition machine learning model is trained on historical item transactions comprising item condition features of historical item transactions, the historical item transactions are previous item transactions associated with the item listing system. Based on the item transaction features of the item, the item condition machine learning model is caused to generate a predicted item condition. The predicted item condition is communicated as a recommended item condition or required item condition.

### BACKGROUND

Users often rely on search systems to help find information stored on computer systems. Such search systems support identifying, for received search queries, search query result items from item databases. For example, a search query, can be executed using a search system to find relevant search result items for the search query. The search can be performed to identify different types of items having different types of item conditions (e.g., brand new, like new, very good, good, acceptable). The search result items may be items for items provided by different users that interpret the guidance for determining the condition of items differently. For example, a seller may review the guidance for item condition grading and determine that an item is “like new” and a buyer, upon receiving the item make determine that the item is more in “acceptable” condition—an then indicate that the item is not as described.

Conventional search systems are limited in their capacity to support a framework for automated and consistent item condition grading. For example, a specific search result item—relative to other search result items—is not intelligently and efficiently determined to have an item condition based on historical transaction data including how other similar items have been graded in the past. With the ever-increasing use of search systems for retrieving electronically stored information, improvements in computing operations and interfaces for search systems can provide more efficient processing of search query item condition information and efficiency in user navigation of item condition related graphical user interfaces in search systems.

### SUMMARY

Embodiments of the present invention relate to methods, systems and computer storage media for providing predicted item conditions for items in an item listing system. A predicted item condition indicates a calculated estimate of a descriptive state of the item based on item transaction features (e.g., item features, transaction features, item condition features, seller features, and buyer features). In particular, item transaction features of an item—associated with the item listing interface—are accessed at an item listing system, such that, an item condition machine learning engine that is trained on historical item transaction features generates predicted item conditions for items. For example, a seller—using an item listing system—may access the item listing interface to list an item for sale. The item transaction features of the item are communicated to an item condition machine learning model. The item condition machine learning model is trained on historical item transaction that are associated with previous item transactions associated with the item listing system. The item condition machine learning model can generate a predicted item condition.

In addition, the predicted item conditions can be based on item condition categories and item conditions within each item condition category. An item condition category refers to a classification of item conditions (e.g., a hierarchical set of item conditions) that are associated with one or more item categories (e.g., books, motors, clothing). For example, a first item category can be associated with books, where the item conditions include brand new, like new, very good, good, and acceptable—and a second item category can be associated with clothing—where the item conditions include new with tags, new without tags, and new with defects. The historical item transactions include transaction information for previous items that have been sold based on item conditions in specific item condition categories. In this way, the item condition machine learning model can be trained for the different types of item condition categories such that predicted item conditions are generated using the additional dimension of item condition categories and their corresponding item conditions. It is contemplated that the item condition machine learning model is trained based on different types of techniques including Convolutional Neural Network and Bidirectional Long Short-Term Memory encoding.

Moreover, interfaces (e.g., seller interface, buyer interface, admin interface) of the item listing system can be used to support generating and communicating predicted item conditions. The interfaces include interface elements that allow effective operation and control of the item condition operations including gathering machine learning training data, inputting data for making machine learning predictions, and receiving feedback data to improve machine learning models. For example, a seller of an item may access an item listing interface to provide item features for an item (e.g., brand, color, item condition, price). The item features—provided by the seller—and other media associated with the item (e.g., item images or item video) can define the item transaction features that are used as input data for predicting an item condition for an item. With regard to communicating the predicted item condition, the predicted item condition can be generated as a recommended item condition or a required item condition via the item listing interface for the seller to select. And, a buyer interface can include a feedback interface associated the predicted item condition. The predicted item condition feedback interface can operate as a mechanism for receiving feedback data for predicted item conditions. For example, a seller may sell an item to a buyer, where the item condition of the item was generated using the item prediction machine learning model. The item transaction features and the predicated item condition feedback data can be used to retrain and improve the item condition machine learning model.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIGS. 1A and 1B are block diagrams of an exemplary search system with an item condition prediction engine, in which embodiments described herein may be employed;

FIGS. 2A and 2B are illustrations of exemplary search system interfaces for an item condition prediction engine, in which embodiments described herein may be employed;

FIG. 3 is a flow diagram showing an exemplary method for implementing a search system with an item condition prediction engine, in accordance with embodiments described herein;

FIG. 4 is a flow diagram showing an exemplary method for implementing a search system with an item condition prediction engine, in accordance with embodiments described herein;

FIG. 5 is a flow diagram showing an exemplary method for implementing a search system with an item condition prediction engine, in accordance with embodiments described herein; and

FIG. 6 is a block diagram of an exemplary computing environment suitable for use in implementing embodiments described herein.

### DETAILED DESCRIPTION

### Overview of Technical Problems, Technical Solutions, and Technological Improvements

Search systems support identifying, for received queries, query result items from item databases. Item databases can specifically be for content systems or item listing systems such as EBAY content system, developed by EBAY INC., of San Jose, Calif. Conventional search systems can be implemented in search engines of item listing systems to support electronic activities associated with buying and selling items (e.g., products or online services). An item listing system is accessible to list different types of items for sale and to buy different types of items that have different condition grades (i.e., item condition). Item conditions let a buyer know whether the buyer is getting something new, used, or something in-between. For example, an item listing system can include item listing features that allow a seller or buyer to choose from one of several preset item condition options. And, item condition options may vary depending on a category of the particular item (e.g., clothing and shoes category—new with tags, new without tags, new with defects, and pre-owned; cars & trucks category—new, certified pre-owned, and used).

Items in an item listing system have different item conditions and are conventionally assigned item conditions through a manual process—for example a seller independently evaluates the item and makes this determination. Moreover, some sellers do not consistently list items for sale, so determining an item condition can be difficult without the proper guidance. For example, the short description of item conditions may be interpreted differently by different sellers; thus opening up the possibility that items will be assigned incorrect or inconsistent item conditions. In addition, buyers may not find that the item condition assigned to an item is representative of the actual state of the item. Often this results in the buyer returning the item because the item provided is “not as described.”

Condition grading items can be challenging for users because conventional search systems rely on description information of different types of items conditions in different categories to assist users in identifying appropriate item conditions for items. For example, a user has to first navigate to an informational webpage that identifies the different item condition categories and corresponding items within each category; review the items conditions associated the an item the user is putting up for sale; and then make a judgement call on which item condition to apply to their item. Some users—sellers and buyers—may bypass these descriptions and simply ascribe their own understanding of what the different available item condition options could mean.

Moreover, users may want to defer to the item listing system provider for additional guidance on item condition grading; however, a conventional item listing system may only provide semi-automated functionality that includes manual intervention from administrators of the item listing system. For example, the user can upload pictures that are accessed by the administrator who may exclusively use manual methods to provide an item condition for the item. Other known techniques for condition grading can be significantly expensive and time-consuming—often also requiring learned judgement from some experts—without enough automation to provide a user experience that seamlessly allows the user to identify a suitable item condition to provide the item for sale on the item listing system. As such, an alternative and more comprehensive approach for facilitating item condition grading in an item listing system—particularly with reference to providing a framework for consistent item condition predictions operations and interfaces in an item listing system.

Embodiments of the present invention relate to methods, systems and computer storage media for providing predicted items conditions for items in an item listing system A predicted item condition indicates a calculated estimate of a descriptive state of the item based on item transaction features (e.g., item features, transaction features, item condition features, seller features, and buyer features). In particular, item transaction features of an item—associated with an item listing interface—are accessed at the item listing system such that, an item condition machine learning engine, which is trained on historical item transactions, generates item predicted item conditions for items.

By way of example, an item listing system can include historical item transactions including item conditions associated with item condition features that are used to train an item condition machine learning model for generating predicted item conditions. Historical item transactions (i.e., item features, transaction features, item condition features, seller features, and buyer features of historical item transaction data) include previous transactions between users of the item listing system. A feature in the item transaction features is a relevant characteristic identified for training the item condition machine learning model. For example, a seller—associated with a historical item transaction—uploaded an item for sale and included item features via an item listing interface. The seller provided the item condition (e.g., an item condition within an item condition category) along with additional item features and transaction features. The seller sold the item to a buyer and the item transaction includes several item transaction features including item features (e.g., color, brand, condition), transaction features (e.g., sale price, buy-it-now or auction), seller features (e.g., professional or new seller) and buyer features (e.g., frequent buyer or first-time buyer).

Item transactions can further be associated with different types of outcomes (e.g., negative feedback but user kept item; negative feedback and user returned item) and attributes from the transactions (e.g., item, price, condition grading classification). In this way, a historical item transaction can include the following: a seller selling a car, where the car was listed as “certified pre-owned,” and a buyer buying the car and responding with negative feedback indicating the car should have been listed as “used” instead. Item transaction features can be captured and stored. The item transaction features are used as training data for a machine learning model to support item condition prediction.

Training the item condition machine learning model can specifically include training based on item condition categories corresponding to item categories. An item condition category refers to a classification of item conditions (e.g., a hierarchical set of item conditions) that are associated with one or more item categories (e.g., books, motors, clothing). The item condition categories can used to train the item condition machine learning engine such that the item condition machine learning engine independently processes items corresponding to the particular item condition category; or the item condition categories can be trained in combination (e.g., a normalizing the item condition across categories) such that insights identified in a first item condition category can be used with a second item condition category. This and other types of historical item transaction features can be used as training data for a machine learning model that provides predicted item conditions. The item condition machine learning model can be trained to include a plurality of sub-models associated with each item condition category, such that predicted item conditions are made based on a corresponding item condition category of a candidate items and corresponding item condition features.

Different machine learning techniques may be used on training data (i.e., historical item transaction data) to train the machine learning model (i.e., machine learning engine or item condition machine learning model). For example, machine learning training can be based on Convolutional Neural Network (“CNN”) and Bidirectional Long Short-Term Memory encoding. For example, a CNN can be used for image recognition, recommendation functionality, image classification, image segmentation, and natural language processing for identify insights in historical item transactions features to support predicting item conditions. Moreover, the historical outcomes and feedback associated with predicted item conditions can be incorporated into the machine learning engine to improve the capacity to accurately make predictions for item conditions. Additional details on a machine learning engine for providing an item condition prediction machine learning model are discussed below.

User interfaces (e.g., seller interface, buyer interface, admin interface) of the item listing system can be used to support generating and communicating predicted item conditions. The interfaces include interface elements that allow effective operation and control of the item condition operations including gathering machine learning training data, accessing item transaction features and other data as input data for making machine learning predictions, soliciting feedback data to improve machine learning models, and receiving manual intervention input data. The item listing interface can specifically be designed to capture information that have been identified—via machine learning—as relevant for prediction of item conditions. A minimum number of pictures and from particular angles can be configured as part of the listing interface to facilitate the item condition prediction operations. As such, based on machine learning insights, the item listing interface can be updated to solicit appropriate item transactions features that support determining predicted item conditions. The item transaction features including item features are communicated to the item condition machine learning model and a predicted item condition is generated. The predicted item condition can be communicated to seller as a recommendation or as a required item condition to be assigned to the item for listing the item. The item listing interface may cause generation prompts that support accepting the recommending item condition or prompts can communicate to the user a required item condition that has been identified for the item condition. The item listing interface may further include additional item listing interface elements that include supplemental data—associated with the predicted item condition—that can be caused to be displayed along with the predicted item condition.

A buyer interface can be provided with a feedback interface that further supports training and improving the machine learning model. The feedback interface may be provided after the transaction with the seller has been completed. The feedback interface can specifically be designed to capture information that have been identified—via machine learning—as relevant for prediction item of item conditions. The feedback data is associated with the item and the item transaction data. In particular, the feedback data can be used to derive item transaction data that is used to train the machine learning model.

A manual intervention interface for the item may be provided for reviewing predicted item conditions and providing altered predicted item conditions based on manual input. The manual intervention interface can be provided based on a predicted item condition (e.g., a predicted item condition score) of an item, such that an administrator of the item listing system can review the details of the item transaction features and update the predicted item condition. For example, a threshold predicted item condition score can be configured for predicted item conditions, such that, based on the threshold predicted item condition score, a predicted item condition is communicated to the manual intervention interface for additional review.

Using the manual intervention interface, the administrator can update the predicted item condition to an altered predicted item condition. The altered predicted item condition can be communicated as the recommended predicted item condition or the required predicted item condition for the item. Other variations and combinations of user interfaces and user interaction models associated with predicting item conditions are contemplated with embodiments of the present disclosure.

The item condition machine learning model processes item transaction features as input data and supports predicted item condition operations. For example, the item features are received from an item listing interface and the item condition machine learning model is caused to generate a predicted item condition. The predicted item condition can be generated with a predicted item condition score that is a confidence score that indicates a confidence level in the predicted item condition. The predicted item condition is communicated to the item listing interface.

The predicted item condition can be presented differently based on the predicted item condition score. For example, thresholds can be associated with the predicted item condition score such that a different user interaction model (e.g., prompts and interface elements) are provided based on the predicted item condition score. For example, based on the predicted item condition score, the predicted item condition can be presented as a recommended item condition or a required predicted item condition. The predicted item condition is further processed via item listing interface, feedback interface, or manual intervention interface, as described above.

Accordingly, embodiments of the present invention of the present invention are directed to simple and efficient methods, systems and computer storage media for providing predicted item conditions for items in an item listing system. Item transaction features of an item —associated with an item listing interface—are accessed at the item listing system. The item transaction features are communicated to an item condition prediction machine learning model. The item condition machine learning model is trained on historical item transactions comprising item condition features of historical item transactions, wherein the historical item transactions are previous item transactions associated with the item listing system. The item condition machine learning model is caused to generate a predicted item condition. The predicted item condition is communicated as a recommended item condition or required item condition.

Embodiments of the present invention have been described with reference to several inventive features (e.g., operations, systems, engines, and components) associated with a search system having an item condition machine learning model for predicting item conditions. Inventive features described include: operations, interfaces, data structures, and arrangement of computing resources associated with providing the functionality described herein relative the item condition machine learning model and user interfaces providing user interaction models. Functionality of the embodiments of the present invention have further been described, by way of an implementation and anecdotal examples—to demonstrate that the operations for providing predicted item conditions generated based on an item condition machine learning model that is trained on historical item transactions—are an unconventional ordered combination of operations that operate with an interface extension engine as a solution to a specific problem in search technology environment to improve computing operations and interfaces for user interface navigation in search systems. Overall, these improvements result in less CPU computation, smaller memory requirements, and increased flexibility in search systems when compared to previous conventional search systems operations performed for similar functionality.

### Overview of Exemplary Environments for Item Condition Prediction Engine Operations

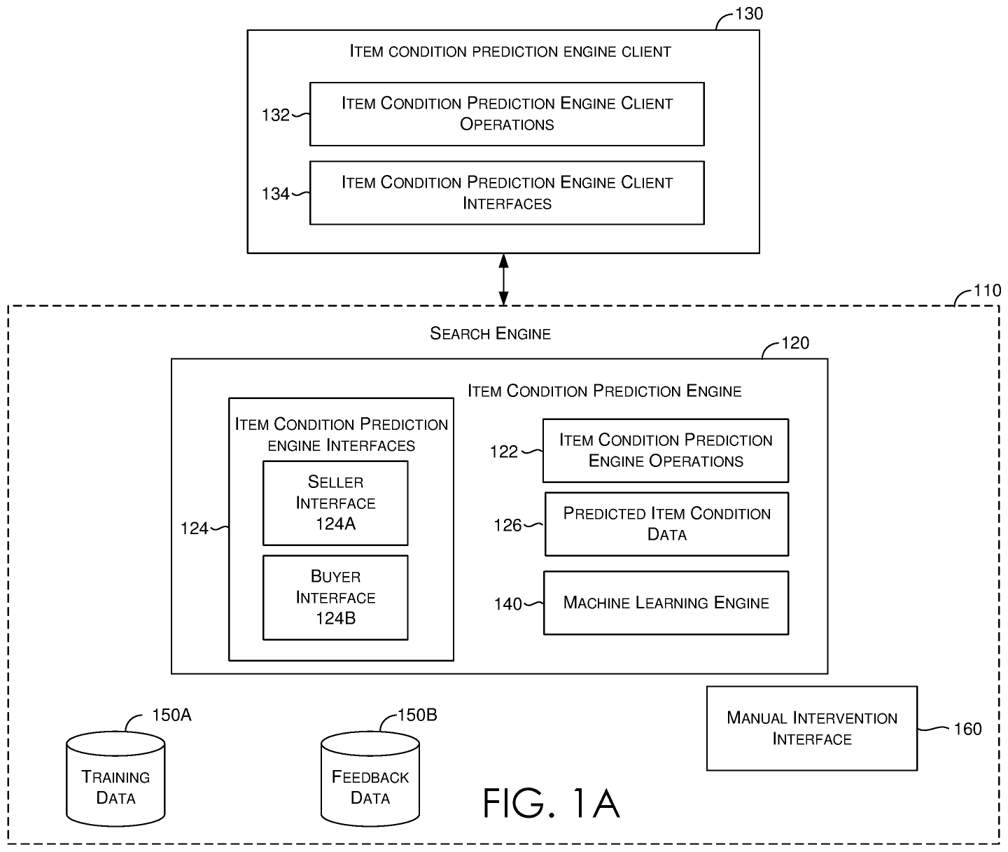

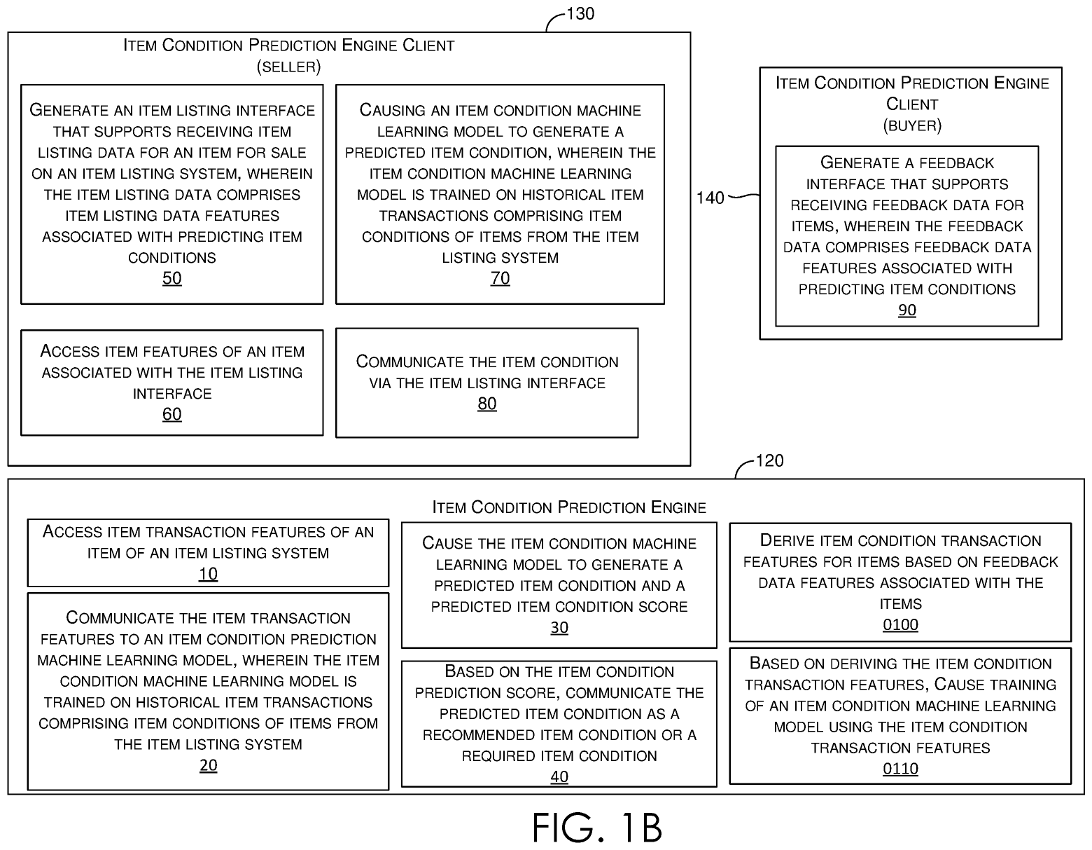

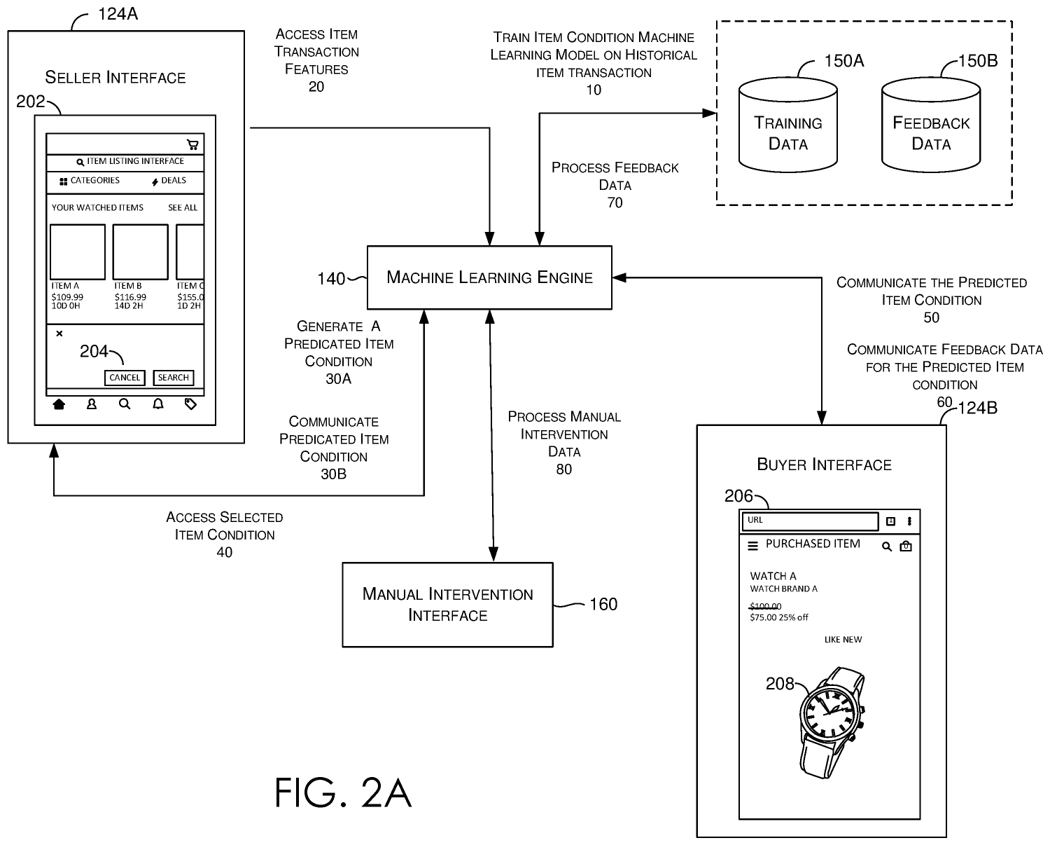

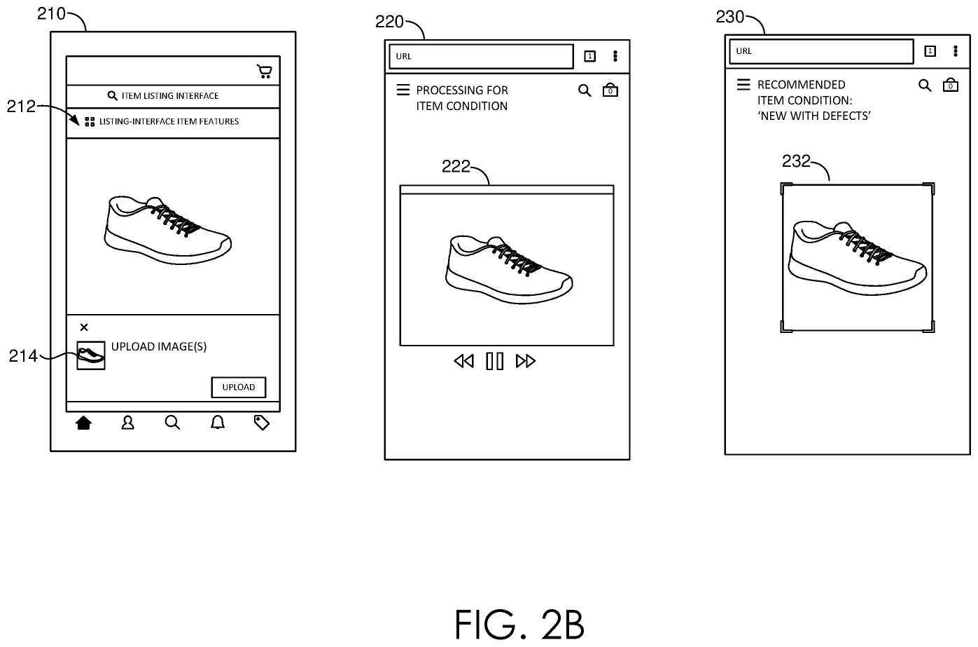

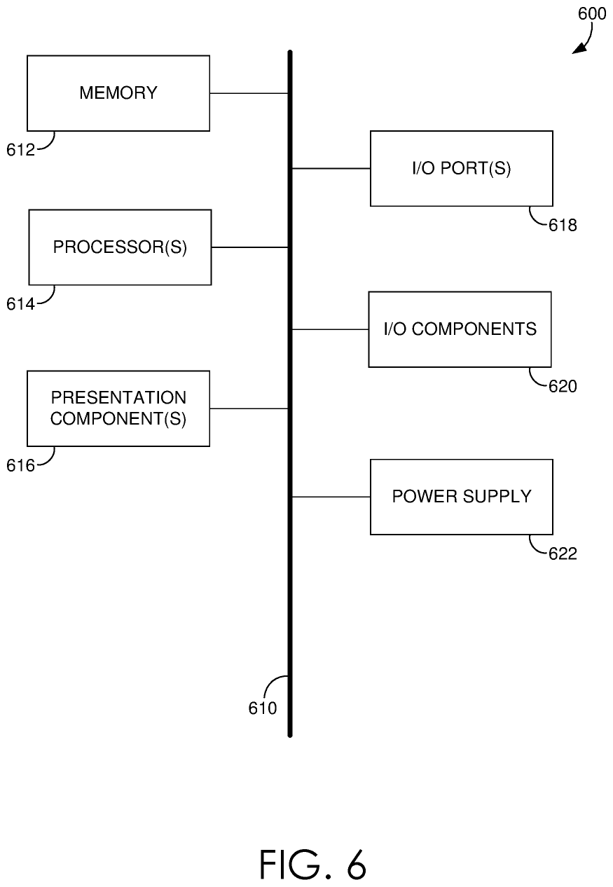

Aspects of the technical solution can be described by way of examples and with reference to FIGS. 1A, 1B, and FIGS. 2A and 2B. FIG. 1A is a block diagram of an exemplary technical solution environment, based on example environments described with reference to FIG. 6 for use in implementing embodiments of the technical solution are shown. Generally the technical solution environment includes a technical solution system suitable for providing the example search system 100 in which methods of the present disclosure may be employed. In particular, FIG. 1A shows a high level architecture of the search system 100 in accordance with implementations of the present disclosure. Among other engines, managers, generators, selectors, or components not shown (collectively referred to herein as “components”), the technical solution environment of search system 100.

With reference to FIG. 1A, FIG. 1A illustrates the exemplary search system 100 in which implementations of the present disclosure may be employed. In particular, FIG. 1A shows a high level architecture of search system 100 having components in accordance with implementations of the present disclosure. Among other components, managers, or engines not shown, search system 100 includes search engine 110—having the item condition prediction engine 120, item condition prediction engine operations 122, item condition prediction engine interfaces 124—including seller interface 124A and buyer interface 124B, predicted item condition data 126, item condition prediction engine client 130—having item condition prediction engine client operations 132 and item condition prediction engine client interfaces 134, machine learning engine 140, training data 150A, feedback data 150B. The components of the search system 100 may operate together to provide functionality for providing predicted item conditions for items in an item listing system.

The item condition prediction engine 120 is responsible for generating and communicating predicted item conditions. The item condition prediction engine 120 accesses item transaction features from the item condition prediction engine client 130. The item transaction features are associated with an item that is listed on an item listing interface (e.g., a seller listing an item) via the item condition prediction engine client 130. The item transaction features include can include the following item features, transaction features, item condition features, seller features and buyer features. An item transaction feature is a relevant characteristic that is identified (e.g., manually or through machine learning insights) for training an item machine learning model for making item condition predictions.

The item condition prediction engine 120 can also include seller interface 124A and buyer interface 124B that include interface elements that support providing user interaction models associated with predicted item conditions. The item condition prediction engine interfaces 124, item condition prediction engine client interfaces 134, the item condition engine operations 122, and the item condition engine client operations 132 are implemented via the item prediction engine 120 and the item condition prediction engine client 130 to communicatively provide the functionality described herein. The seller interface 124A may include instructions for generating interface elements to receive item transaction features used to generate a predicted item condition, and the buyer interface 124B may include instructions for generating interface elements to receive feedback data that is used to train the item condition machine learning model. The predicted item condition can specifically provide for different user interaction models via a seller interface or a buyer interface. For example, a seller interface may receive a predicted item condition as a required item condition or a recommended item condition such that the seller interface further includes user interface elements—including additional predicted item condition information—to support process a corresponding item for sale based on the predicted item condition. The buyer interface can similarly include user interface elements that support receiving feedback data associated with a predicted item condition of an item bought by a buyer. Other variations and combinations of user interface elements associated predicted item conditions are contemplated with embodiment of this disclosure.

The machine learning engine 140 is trained on historical item transaction to support generating predicted item conditions. The training data including historical item transactions may be analyzed at a character level using convolution network techniques. Convolution neural networks support deep learning without artificially embedding knowledge about words, phrases, sentences, or any other syntactic or semantic structures associated with language. Bi-directional long short-term memory (Bi-LSTM) is an artificial neural network where connections between units form a directed graph along a sequence. In particular, Bi-LSTM may be used for processing sequential data. The machine learning engine 140 may operate based on a convolutional neural network or Bi-LSTM for encoding and classifying item transaction features. For example, the convolution neural network may be used to encode item transaction features of historical item transactions such that a predicated item condition can be generated for an item based on a threshold similarity between the item transactions features of the item and item transaction features of historical item transactions.

The machine learning engine 140 is responsible for comparing the item transaction features of an item to the item transaction features of historical item transactions. In one implementation, the item transaction features and historical item transactions can be compared based on item condition categories. For example, an item condition machine learning model is further trained—via the machine learning engine based item condition categories, where the item condition machine learning model comprises a plurality of sub-models associated with each item condition category. In this way, predicted item conditions are made based on a corresponding item condition category of a candidate items and corresponding item condition features

The machine learning engine 140 further supports comparing a plurality of item transaction features of an item to item transaction features of historical item transactions. The machine learning engine 140 includes an item condition machine learning model that includes a pre-trained machine learning model associated with historical item transactions. The plurality of item transaction features of an item can be compared to item transaction features of historical item transactions. A determination (e.g., a machine learning engine prediction) can be made that an item should have a particular item condition based on a threshold similarity (e.g., a predicted item condition score) between the item transaction features of the item and the item transaction features of historical transaction features. As such, an indication of a potential fraudulent item listing is generated for the listing.

The manual intervention interface 160 is responsible to provide access to the item condition engine 120 to manually alter a predicted item condition. The manually intervention interface can be provide based on a set of rules that trigger manual review of the predicted item condition. The manual intervention interface 160 can be provided based on a predicted item condition (e.g., a predicted item condition score) of an item, such that an administrator of the item listing system can review the details of the item transaction features and update the predicted item condition. For example, a threshold predicted item condition score can be configured for predicted item conditions, such that, based on the threshold predicted item condition score, a predicted item condition is communicated to the manual intervention interface for additional review.

Turning to FIG. 1B, FIG. 1B illustrates the item condition prediction engine 120, the item condition prediction engine client 130, and item condition prediction engine client 140. The item condition prediction engine 120, item condition prediction engine client 130, item condition prediction engine client 140 are configured to perform the operations identified. At block 10, the item condition prediction engine 120 accesses item features of an item of an item listing system, and at block 20, communicates the item features to an item condition prediction machine learning model. The item condition machine learning model is trained on historical item transactions. At block 30, item condition prediction engine 120, causes the item condition machine learning model to generate a predicted item condition and a predicted item condition score. At block 40, the item condition prediction engine 120, based on the item condition prediction score, communicates the predicted item condition as a recommended item condition or a required item condition.

At block 50, the item condition prediction engine client 130, generates an item listing interface that supports receiving item listing data for an item for sale on an item listing system. The item listing data comprises item listing data features associated with predicting item conditions. At block 60, the item condition prediction engine accesses item features of an item associated with the item listing interfaces, and, at block 70, causes the an item condition machine model to generate a predicted item condition. The item condition machine learning model is trained on item condition transaction features of historical item transactions. At block 80, the item condition prediction engine 80, communicates the item

Turning to FIG. 2A, FIG. 2A illustrates seller interface 124A having seller interface portion 202 and representative seller interface element 204 and buyer interface 124B having buyer interface portion 206 and representative buyer interface element 208. The seller interface portion 202 and the buyer interface portion 206 support generating and communicating predicted item conditions. The representative seller interface element 204 and the representative buyer interface element 208 allow for effective operation and control of the item condition operations including gather machine learning data, inputting data for making machine learning predictions, and receiving feedback data to improve machine learning models. For example, a seller of an item may access an item listing interface to provide item features for an item (e.g., brand, color, item condition, price). The item features—provided by the seller—and other media associated with the item (e.g., item images or item video) can define the item transaction features that are used as input data for predicting an item condition for an item. With regard to communicating the predicted item condition, the predicted item condition can be generated as recommended item condition or required item condition via the item listing interface for the seller to select. And, a buyer interface can include a feedback interface associated the predicted item condition. The predicted item condition feedback interface can operate as a mechanism for receiving feedback data for predicted item conditions.

Operationally, the item listing system executes instructions for performing the following: at block 10, train item condition machine learning model on historical item transactions; at block 20, access item transaction features of an item; at block 30A, using machine learning engine 140, generate a predicted item condition based on the item features of the item; at block 30B, communicate a predicted item condition; at block 40, access a selected item condition; at block 50, communicate the predicted item condition; at block 60, communicate feedback data for the predicted item condition; at block 70, process feedback data; at block 80, using the manual intervention interface 160, process manual intervention data.

With reference to FIG. 2B, FIG. 2B illustrates seller interface portion 210 having representative seller interface element 212 and representative seller interface element 214, seller interface portion 220 having representative seller interface element 222, and seller interface portion 230 having representative seller interface element 232. The represent seller interface element 210, representative seller interface element 212, and representative seller interface element can having corresponding interface element features discussed with reference to FIG. 2A and throughout the present disclosure. In particular, FIG. 2B illustrates a series of prompts associated with an item listing interface where seller interface elements support receiving item transaction features that are relevant to generating a predicted item condition and providing a user interface model for communicating the predicted item condition and receiving a selection of the predicted item condition. For example, the seller interface portion 210 can provide seller interface elements for listing an item having item transaction features that are relevant to generating a predicted item condition, the seller interface portion 220 can provide seller interface elements that indicate that a predicted item condition is being generated for the item based on the item transaction features, and the seller interface portion 230 can provide seller interface elements that indicate a predicted item condition (e.g., a recommended predicted item condition or required item condition) along with additional item transaction features and information associated with generating the predicted item condition. Other variations and combinations of seller interfaces, seller interface elements, and user interaction models are contemplated with embodiments of the present disclosure.

### Exemplary Methods for Providing Item Condition Prediction Engine Operations

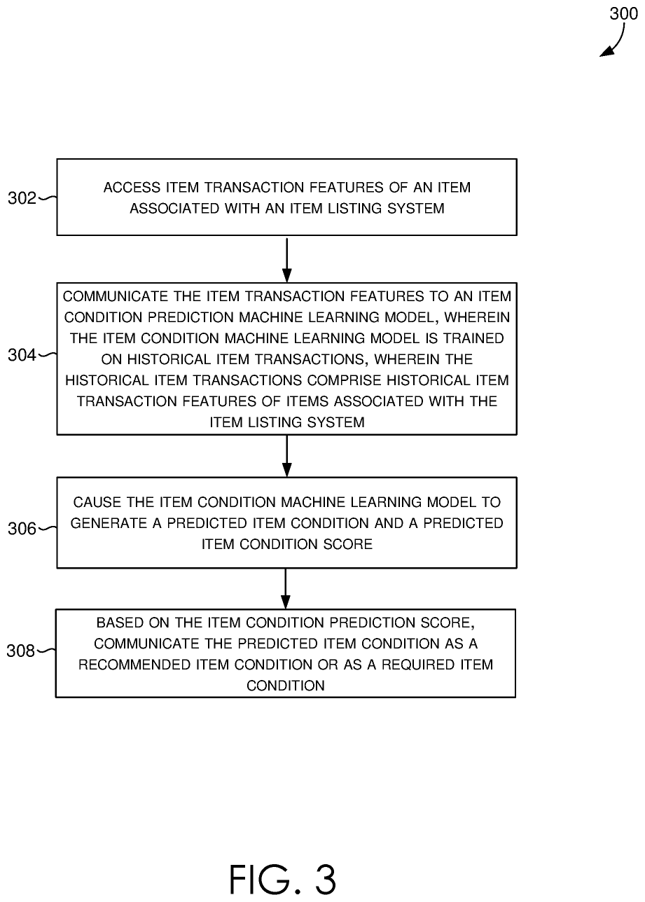

With reference to FIGS. 3, 4 and 5, flow diagrams illustrate methods for providing predicted item conditions for items in an item listing system. The methods may be performed using the search system, item condition prediction engine, and item condition prediction engine client, described herein. In embodiments, one or more computer-storage media having computer-executable or computer-useable instructions embodied thereon that, when executed, by one or more processors can cause the one or more processors to perform the methods (e.g., computer-implemented method) in the search system (e.g., a computerized system or computing system).

Turning to FIG. 3, a flow diagram is provided that illustrates a method 300 for providing predicted item conditions for items in an item listing system. At block 302, item transaction features of an item associated with an item listing system are accessed. At block 304, the item transaction feature are communicated to an item condition prediction machine learning model. The item condition machine learning model is trained on historical item transactions. The historical item transactions comprise historical item transaction features of items associated with the item listing system. At block 306, the item condition machine learning model is caused to generated a predicted item condition and a predicted item condition score. At block 308, based on the item condition score, the predicted item condition score is communicated as a recommended item condition or as a required item condition.

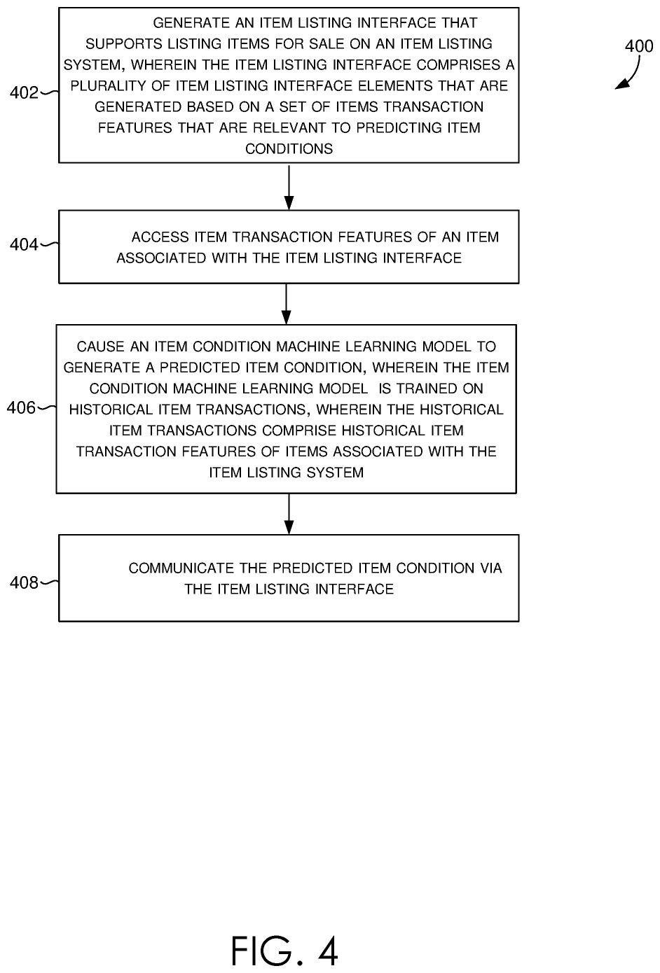

Turning to FIG. 4, a flow diagram is provided that illustrates a method 400 for providing predicted item conditions for items in an item listing system. At block 402, an item listing interface that supports listing items for sale on an item listing system is generated. The item listing interface comprises a plurality of item listing interface elements that are generated based on a set of item transaction features that are relevant to predicting item conditions. At block 404, item transaction features of an item associated with the item listing interface are accessed. At block 406, an item condition machine learning model is caused to generate a predicted item condition. The item condition model is trained on is trained on historical item transactions, where the historical item transactions comprise historical item transaction features of items associated with the item listing system. At block 408, the predicted item condition is communicated via the item listing interface.

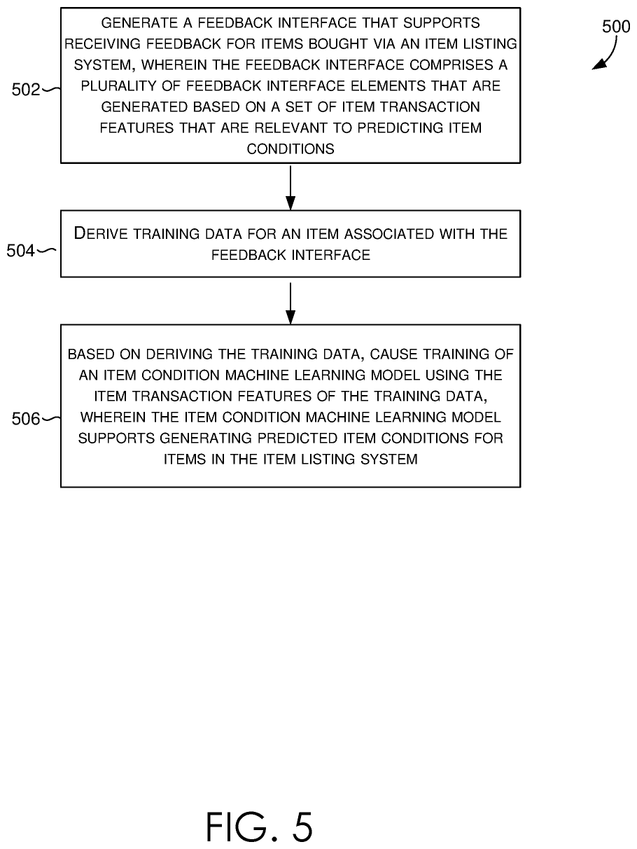

Turning to FIG. 5, a flow diagram is provided that illustrates a method 400 for providing predicted item conditions for items in an item listing system. At block 502, a feedback interface that support receiving feedback for items bought via an item listing system is generated. The feedback interface comprises a plurality of feedback interface elements that are generated based on a set of item transaction features that are relevant to predicting item conditions. At block 504, training data for an item associated with the feedback interface is derived. At block 506, based on deriving training data, training of an item condition machine learning model using the item transaction features of the training data is caused. The item condition machine learning model supports generating predicted item conditions for items in the item listing system.

### Example Search System Environment

With reference to the search system 100, embodiments described herein support providing query result items based on an item condition prediction engine. The search system components refer to integrated components that implement the image search system. The integrated components refer to the hardware architecture and software framework that support functionality using the search system components. The hardware architecture refers to physical components and interrelationships thereof and the software framework refers to software providing functionality that may be implemented with hardware operated on a device. The end-to-end software-based search system may operate within the other components to operate computer hardware to provide search system functionality. As such, the search system components may manage resources and provide services for the search system functionality. Any other variations and combinations thereof are contemplated with embodiments of the present invention.

By way of example, the search system may include an API library that includes specifications for routines, data structures, object classes, and variables may support the interaction the hardware architecture of the device and the software framework of the search system. These APIs include configuration specifications for the search system such that the components therein may communicate with each other for form generation, as described herein.

With reference to FIG. 1A, FIG. 1A illustrates an exemplary search system 100 in which implementations of the present disclosure may be employed. In particular, FIG. 1A shows a high level architecture of search system 100 having components in accordance with implementations of the present disclosure. It should be understood that this and other arrangements described herein are set forth only as examples. In addition, a system, as used herein, refers to any device, process, or service or combination thereof. As used herein, engine is synonymous with system unless otherwise stated. A system may be implemented using components or generators as hardware, software, firmware, a special-purpose device, or any combination thereof. A system may be integrated into a single device or it may be distributed over multiple devices. The various components or generators of a system may be co-located or distributed. For example, although discussed for clarity as the content application component, operations discussed may be performed in a distributed manner. The system may be formed from other systems and components thereof. It should be understood that this and other arrangements described herein are set forth only as examples.

Having identified various component of the search system 100, it is noted that any number of components may be employed to achieve the desired functionality within the scope of the present disclosure. Although the various components of FIG. 1A are shown with lines for the sake of clarity, in reality, delineating various components is not so clear, and metaphorically, the lines may more accurately be grey or fuzzy. Further, although some components of FIG. 1A are depicted as single components, the depictions are exemplary in nature and in number and are not to be construed as limiting for all implementations of the present disclosure. The search system 100 functionality may be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A computer-implemented method, the method comprising:
accessing item transaction features of an item of an item listing system;
communicating the item transaction features to an item condition prediction machine learning model, wherein the item condition machine learning model is trained on historical item transactions, wherein the historical item transactions comprise historical item transaction features of items associated with the item listing system;
causing the item condition machine learning model to generate a predicted condition and a predicted item condition score based on the item transaction features; and
based on the item condition prediction score, communicating the item condition.

2. The method of claim 1, wherein item transaction features include each of the following: item features, transaction features, item condition features, seller features and buyer features, wherein a feature in the item transaction features is a relevant characteristic identified for training the item condition machine learning model, wherein the item transaction features are associated with an item listing interface that is accessible by a seller accessing the item listing system.

3. The method of claim 1, wherein item transaction features support generating the predicted item condition that indicates a calculated estimate of a descriptive state of the item, wherein the predicted item condition is associated with a threshold predicted item condition score that triggers corresponding user interface interactions based on the meeting or not meeting the threshold predicted item condition score.

4. The method of claim 1, wherein the item condition machine learning model is further trained based on item condition categories, wherein the item condition machine learning model comprises a plurality of sub-models associated with each item condition category such that predicted item conditions are made based on a corresponding item condition category of a candidate items and corresponding item condition features.

5. The method of claim 1, wherein generating the prediction item condition comprising comparing the item transaction features of the item to the historical item transaction features, wherein comparing the item transaction features to the historical item transaction feature comprises comparing at least item condition features of the item to item condition features of the historical item transactions.

6. The method of claim 1, wherein the item condition is configurable for communication as each of the following: a recommended item condition; and a required item condition

7. The method of claim 1, further comprising generating a predicted item condition feedback interface that support receiving machine learning feedback data for item bought via the item listing system;
receiving, via the feedback interface, wherein the feedback data based on a set of item features that are relevant to predicting item conditions;
based on the feedback data, deriving item condition transaction features for the feedback interface; and
based on deriving the item condition transaction features, causing training of the item condition machine learning model using the item condition transaction features, wherein the item condition machine learning model supports generating item conditions for items in the item listing system.

8. One or more computer storage media having computer-executable instructions embodied thereon that, when executed, by one or more processors, cause the one or more processors to perform a method, the method comprising:
accessing item features of an item associated with an item listing interface of item listing system;
causing an item condition machine learning model to generate a predicted item condition based on the item features, wherein the item condition machine learning model is trained on historical item transactions, wherein the historical item transactions comprise historical item transaction features of items associated with the item listing system; and
communicating the predicted item condition via the item listing interface.

9. The media of claim 8, wherein item transaction features include each of the following: item features, transaction features, item condition features, seller features and buyer features, wherein a feature in the item transaction features is a relevant characteristic identified for training the item condition machine learning model, wherein the item transaction features are associated with an item listing interface that is accessible by a seller accessing the item listing system.

10. The media of claim 8, wherein item transaction features support generating the predicted item condition that indicates a calculated estimate of a descriptive state of the item, wherein the predicted item condition is associated with a threshold predicted item condition score that triggers corresponding user interface interactions based on the meeting or not meeting the threshold predicted item condition score.

11. The media of claim 8, wherein the item condition machine learning model is further trained based item condition categories, wherein the item condition machine learning model comprises a plurality of sub-models associated with each item condition category such that predicted item conditions are made based on a corresponding item condition category of a candidate items and corresponding item condition features.

12. The media of claim 8, wherein generating the prediction item condition comprising comparing the item transaction features of the item to the historical item transaction features, wherein comparing the item transaction features to the historical item transaction feature comprises comparing at least item condition features of the item to item condition features of the historical item transactions.

13. The media of claim 8, further comprising generating a manual intervention interface that allows an administrator to update the predicted item condition.

14. The media of claim 8, wherein the one or more processors further execute:
generating a predicted item condition feedback interface that support receiving machine learning feedback data for item bought via the item listing system;
receiving, via the feedback interface, wherein the feedback data based on a set of item features that are relevant to predicting item conditions;
based on the feedback data, deriving item condition transaction features for the feedback interface; and
based on deriving the item condition transaction features, causing training of the item condition machine learning model using the item condition transaction features, wherein the item condition machine learning model supports generating item conditions for items in the item listing system.

15. A system, the system comprising:
one or more processors; and
one or more computer storage media storing computer-useable instructions that, when used by the one or more processors, cause the one or more processors to execute:
accessing item features of an item associated an item listing interface of item listing system;
causing an item condition machine learning model to generate a predicted item condition, wherein the item condition machine learning model is trained on item condition transaction features of historical transactions comprising item conditions of items in the item listing system; and
communicating the item condition via the item listing interface.

16. The system of claim 15, wherein item transaction features include each of the following: item features, transaction features, item condition features, seller features and buyer features, wherein a feature in the item transaction features is a relevant characteristic identified for training the item condition machine learning model, wherein the item transaction features are associated with an item listing interface that is accessible by a seller accessing the item listing system.

17. The system of claim 15, wherein item transaction features support generating the predicted item condition that indicates a calculated estimate of a descriptive state of the item, wherein the predicted item condition is associated with a threshold predicted item condition score that triggers corresponding user interface interactions based on the meeting or not meeting the threshold predicted item condition score.

18. The system of claim 15, wherein the item condition machine learning model is further trained based item condition categories, wherein the item condition machine learning model comprises a plurality of sub-models associated with each item condition category such that predicted item conditions are made based on a corresponding item condition category of a candidate items and corresponding item condition features.

19. The system of claim 15, wherein generating the prediction item condition comprising comparing the item transaction features of the item to the historical item transaction features, wherein comparing the item transaction features to the historical item transaction feature comprises comparing at least item condition features of the item to item condition features of the historical item transactions.

20. The system of claim 15, wherein the one or more processors further execute:
generating a predicted item condition feedback interface that support receiving machine learning feedback data for item bought via the item listing system;
receiving, via the feedback interface, wherein the feedback data based on a set of item features that are relevant to predicting item conditions;
based on the feedback data, deriving item condition transaction features for the feedback interface; and
based on deriving the item condition transaction features, causing training of the item condition machine learning model using the item condition transaction features, wherein the item condition machine learning model supports generating item conditions for items in the item listing system.
